(19) United States
(12) Patent Application Publication
(10) Pub. No.: US 2017/0124902 A1
(43) Pub. Date: May 4, 2017

(54) SYSTEM AND METHOD FOR ENABLING A USER TO OVERCOME LOW SELF-ESTEEM

(71) Applicants: Jonnalagadda SASIDHAR, Sleepy Hollow, NY (US); Pranav Kumar MISHRA, Burdwan (IN); Manisha Naresh NAGPAL, Bangalore (IN)

(72) Inventors: Jonnalagadda SASIDHAR, Sleepy Hollow, NY (US); Pranav Kumar MISHRA, Burdwan (IN); Manisha Naresh NAGPAL, Bangalore (IN)

(73) Assignee: DHARMA LIFE SCIENCES LLC, Sleepy Hollow, NY (US)

(21) Appl. No.: 14/934,152

(22) Filed: Nov. 6, 2015

Related U.S. Application Data
(63) Continuation-in-part of application No. 14/931,868, filed on Nov. 4, 2015.

(51) Int. Cl. G09B 19/00; G09B 5/02

(52) U.S. Cl. CPC G09B 19/00; G09B 5/02

(57) ABSTRACT

A method and system are provided for enabling a user to overcome low self-esteem. The method includes enabling the user to engage in a first activity, a second activity and a third activity. The three activities are performed in virtual environment. The first activity is directed to rewire a first defective wiring of the brain. The first defective wiring results in an individual mostly attributing negative events to self and positive events to the environment. The second activity is directed to rewire a second defective wiring of the brain. The second defective wiring results in an individual finding negative aspects in most events. The third activity is directed to rewire a third defective wiring of the brain. The third defective wiring results in an individual fearing rejection by other people. The symptom of the first, the second and the third defective wirings is low self-esteem.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome low self-esteem, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, low self-esteem may be caused by genetic predisposition and negative experiences in early life that lower self-regard.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a person who is an individual with low self-esteem may include, repeated negative thinking about oneself, tendency to compare oneself with others, tendency to set unrealistic expectations for self, tendency to avoid situations that predict failure, low motivation to fulfill their goals/desires, being defensive when merely being asked for an opinion, idea, or their input on a decision, hyper vigilance—being constantly anxious and fearful of making a mistake and being overly watchful of the behavior of others, lacking assertiveness, being passive aggressive in behavior, poor communication and social skills, among others.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a focused manner.

In light of the foregoing discussion there is a need for an improved technique to overcome low self-esteem, which is a weak trait of personality.

### SUMMARY

An embodiment provides a system for enabling a user to overcome low self-esteem. The system includes an activity module. The activity module is configured to enable the user to engage in at least a first activity in a virtual environment, wherein the first activity is directed to rewire a first defective wiring of the brain, wherein the first defective wiring results in an individual mostly attributing negative events to self and positive events to the environment; enable the user to engage in at least a second activity in the virtual environment, wherein the second activity is directed to rewire a second defective wiring of the brain, wherein the second defective wiring results in an individual finding negative aspects in most events; enable the user to engage in at least a third activity in the virtual environment, wherein the third activity is directed to rewire a third defective wiring of the brain, wherein the third defective wiring results in an individual fearing rejection by other people, wherein symptom of the first, the second and the third defective wirings is low self-esteem; provide automated instructions to the user to engage in at least one activity, wherein the one activity is performed in a real world environment, wherein the activity is directed to rewire the first defective wiring of the brain; provide automated instructions to the user to engage in yet another activity, wherein the yet another activity is performed in the real world environment, wherein the yet another activity is directed to rewire the second defective wiring of the brain; and provide automated instructions to the user to engage in still another activity, wherein the still another activity is performed in the real world environment, wherein the still another activity is directed to rewire the third defective wiring of the brain.

Another embodiment provides a method for enabling a user to overcome low self-esteem. The method includes enabling the user to engage in at least a first activity in a virtual environment, wherein the first activity is directed to rewire a first defective wiring of the brain, wherein the first defective wiring results in an individual mostly attributing negative events to self and positive events to the environment; enabling the user to engage in at least a second activity in the virtual environment, wherein the second activity is directed to rewire a second defective wiring of the brain, wherein the second defective wiring results in an individual finding negative aspects in most events; and enabling the user to engage in at least a third activity in the virtual environment, wherein the third activity is directed to rewire a third defective wiring of the brain, wherein the third defective wiring results in an individual fearing rejection by other people, wherein symptom of the first, the second and the third defective wirings is low self-esteem.

Yet another embodiment provides a system for enabling a user to overcome low self-esteem. The system includes an activity module configured to enable the user to engage in at least a first activity in a virtual environment, wherein the first activity is directed to rewire a first defective wiring of the brain, wherein the first defective wiring results in an individual mostly attributing negative events to self and positive events to the environment; enable the user to engage in at least a second activity in the virtual environment, wherein the second activity is directed to rewire a second defective wiring of the brain, wherein the second defective wiring results in an individual finding negative aspects in most events; and enable the user to engage in at least a third activity in the virtual environment, wherein the third activity is directed to rewire a third defective wiring of the brain, wherein the third defective wiring results in an individual fearing rejection by other people, wherein symptom of the first, the second and the third defective wirings is low self-esteem.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome low self-esteem;

FIG. 2 is a block diagram of an exemplary activity module 200 to overcome low self-esteem:

FIG. 2A is a block diagram of an exemplary behavioral traits database 202 of the activity module 200;

FIG. 2B is a block diagram of an exemplary collection of games 204 present in the activity module 200 to overcome low self-esteem:

FIG. 2C is a block diagram of an exemplary actions database 206 of the activity module 200 to overcome low self-esteem; and

FIGS. 3A, 3B and 3C illustrate a flowchart of an exemplary method for overcoming low self-esteem.

### DETAILED DESCRIPTION

### I. OVERVIEW

### II. PRINCIPLE

### III. SYSTEM ARCHITECTURE

### IV. MODULES OF SYSTEM TO OVERCOME LOW SELF-ESTEEM

### V. METHOD FOR OVERCOMING LOW SELF-ESTEEM

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome low self-esteem, which is a weak behavioral trait. The solution is based on a principle that genetic and environmental factors (may be referred to as “cause”) cause defects in human brain wiring (may be referred to as “defect”), and such defects in human brain wiring express themselves in the form of low self-esteem (may be referred to as “symptoms”); hence, to overcome low self-esteem, the defective brain wirings have to be rewired, thereby providing a wholesome and long term solution to weak behavioral traits.

In an embodiment, a system is provided to overcome low self-esteem. The system may include an activity module. The activity module may be configured to enable the user to engage in activities in a virtual environment. The activities in the virtual environment facilitate rewiring of defective brain wirings, wherein the symptom of the defective brain wirings is low self-esteem. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may a plurality of levels in the brain game. Each level in the game may have to be successfully completed by the user to unlock a subsequent higher level in the game.

The exposure activity may take place in the real world environment, subsequent to the brain games. There may be a plurality of levels in the exposure activity.

### II. Principle

Self-esteem may be a term used to reflect a person's overall evaluation of his/her own worth. Self-esteem may be a sum of self-confidence and self-respect. Self-confidence may be an evaluation that a person makes with regard to how they would be in comparison with others. Self-respect may be the way a person values himself/herself irrespective of their positives or negatives.

Self-esteem is in fact symptom or consequence of the way an individual's brain is wired. The way an individual's brain is wired is based on the joint influence of genetic and environmental factors. With regards to each kind of brain wiring, genetic and environmental factors may work together in different proportions.

With regards to low self-esteem, the brain of a person with low self-esteem is wired such that the person mostly attributes negative events to self and positive events to the environment, which may be considered as a defective brain wiring. Additionally, the brain of the person with low self-esteem is wired to find negative aspects in most events, which may be considered as another defective brain wiring. Further, the brain of the person with low self-esteem is wired such that the person fears rejection by other people, which may be considered as yet another defective brain wiring. Such defective brain wirings may have been caused by genetic predisposition and negative experiences in early life that lower self-regard.

A wholesome approach to overcome or eradicate low self-esteem in a person would be to implement ways to rectify defect in the brain wiring. Embodiments provide a solution to rewire the defective brain wirings (addressing the defect) rather than just addressing the behavioral trait (symptom) without addressing the core defect. The solution is directed towards rewiring the defective brain wirings such that the ability to attribute positive and negative events correctly to either the environment or self is increased, the person finds positive aspects in different life events and ability is increased to separate people who will/have accepted/rejected the person over time, irrespective of specific events.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals with low self esteem mostly attributes negative events to self and positive events to the environment, find negative aspects in most events and fear rejection by other people, which may be considered as yet another defective brain wiring. Different brain regions and neural network of the individual are responsible for such defects. Medial Prefrontal Cortex (MPFC). Anterior Cingulate Cortex (ACC) (Ventral Cingulate Cortex “vACC” and dorsal Cingulate Cortex “dACC”), Lateral Orbito Frontal Cortex (LOFC), Right Temo-Parietal Junction (rTPJ) and Nucleus Accumbens (NA) or Striatum are depicted as blocks. Individuals with low self-esteem have reduced levels of regional grey matter volume in structures (rTPJ and ACC), which may play a role in emotional self-regulation in response to stimuli.

Individuals with low self-esteem have greater activity in MPFC. It is involved in self-referential processing that underlies cognitive processes associated with the self. Because feelings of self-esteem must draw information from one's self-representation, it stands to reason that the MPFC is recruited when processing information during self-evaluation. Individuals with low self esteem have a strong connection between MPFC and NA, which results in negative personalization-processing every event negatively and relating that to the self.

Further, individuals with low self-esteem have higher activity in LOFC. The connection between LOFC and the right ventral striatum is very strong. Activation in the LOFC is associated with a reduction in positively biased self-evaluation.

The ACC is the frontal part of the cingulate cortex and is divided into two closely associated structures known as vACC and dACC. dACC is involved in the processing of negative stimuli. The vACC is associated with assigning emotional value to the stimuli. vACC is further connected to the amygdala, nucleus accumbens and hypothalamus, among others. It has shown to be involved in emotion and stress regulation. Heightened grey matter volume in the dorsal part of the ACC causes a drop in negative effect due to reappraisal in response to negative stimuli; however, individuals with low self-esteem show reduced gray matter volume and thus, are unable to reappraise any negative stimuli. The vACC associates the positive emotions with any stimuli. In case of people having low self-esteem, both the parts of ACC do not work optimally, which leads to negative evaluation of the self and fear of rejection.

Grey matter volume in rTPJ is positively correlated with high self-esteem. rTPJ is linked to theory of mind process and, especially to thinking about the thoughts of others and the way they perceive you. Activation in the rTPJ may predict a drop in negative affect due to reappraisal along with the dorsal ACC. However, reduced grey matter in rTPJ is found in individuals with low self-esteem and thus, they make incorrect conclusions about how other people perceive them.

According to what has been mentioned above, in order to increase an individual's self-esteem, it may be essential to decrease the activity in the MPFC and LOFC while increasing the activity in ACC and rTPJ through games and gradual exposure.

### III. System Architecture

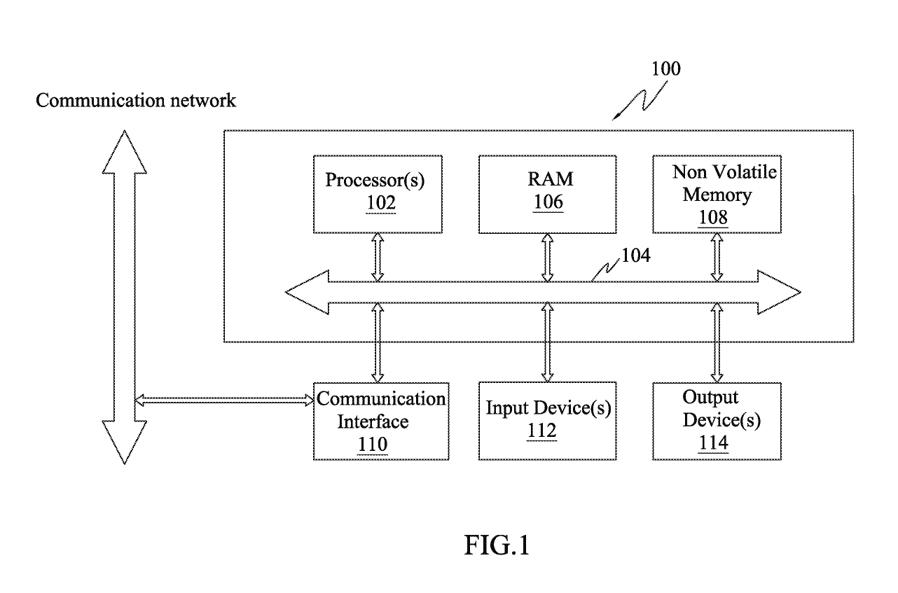

Referring to the figures, more particularly to FIG. 1, an exemplary architecture of an exemplary system 100 to overcome low self-esteem is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Low Self-Esteem

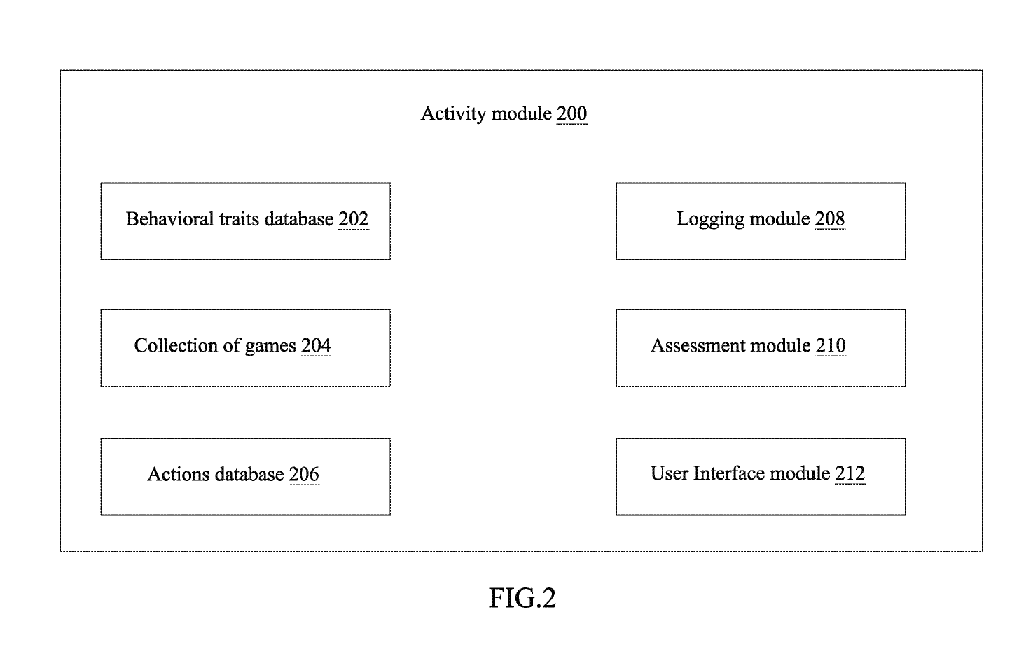

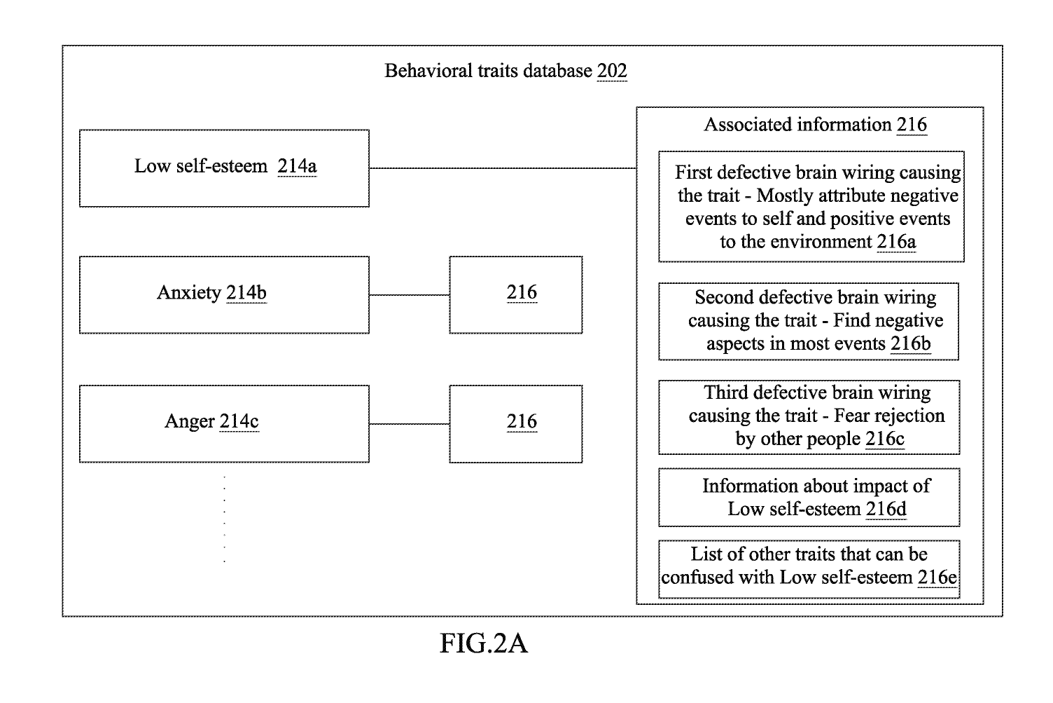

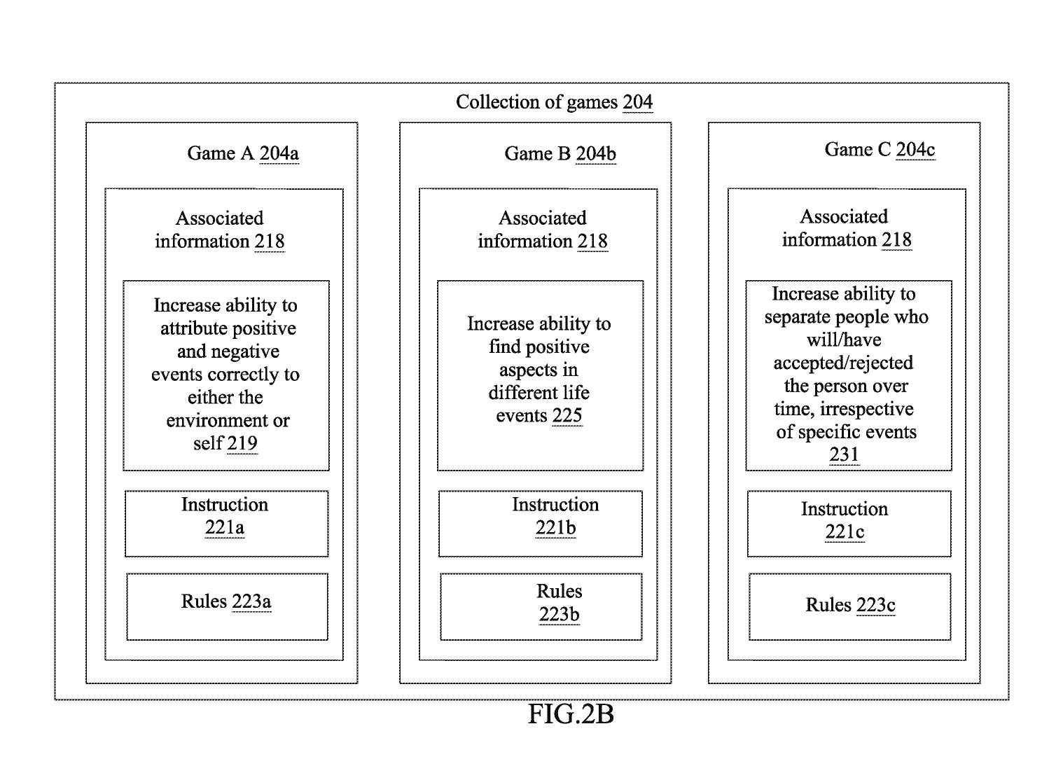

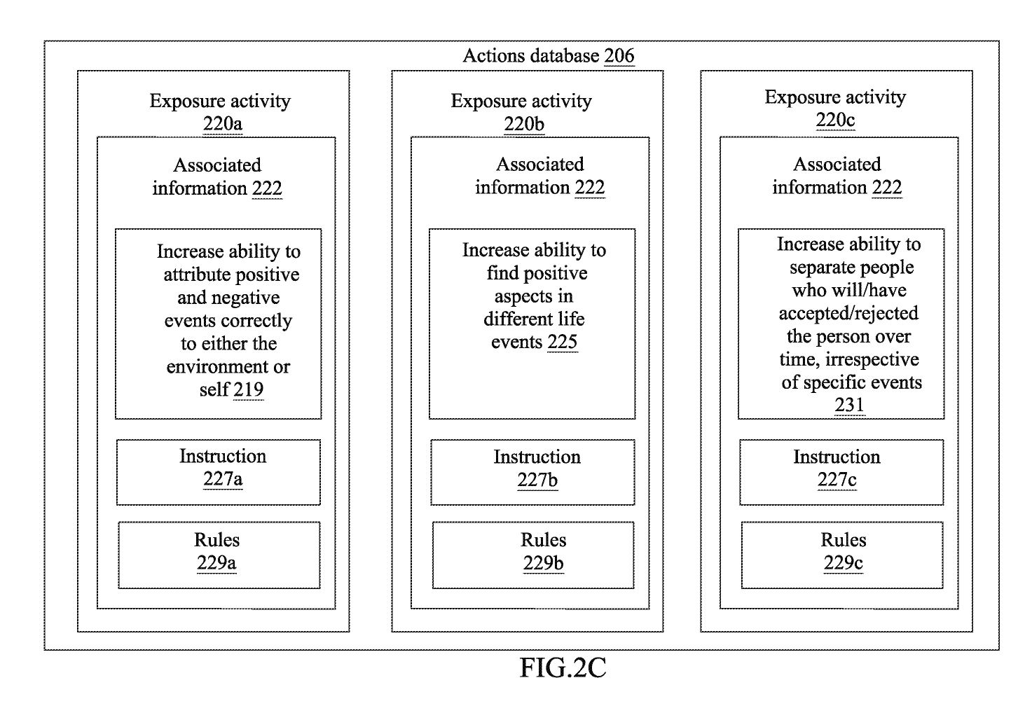

Referring to the figures, and more particularly to FIG. 2, the system 100 includes various modules for enabling users to overcome low self-esteem. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, low self-esteem 214a, anxiety 214b and anger 214c, among others. The traits database 202 may further include, with respect to one or more of the behavioral traits, information associated 216 with the trait 214.

With regards to low self-esteem 214a, the associated information 216 may include information corresponding to the defective brain wirings (defects) 216a, 216b, 216c causing low self-esteem (symptom of the defect), information about impact 216d of low self-esteem 214a on a person, and a list 216e comprising one or more traits that may be confused with low self-esteem 214a, among other information. Some or all of the associated information 216 may be displayed to the user of the activity module 200.

A first defective brain wiring 216a causing low self-esteem 214a is the brain wiring causing an individual to mostly attribute negative events to self and positive events to the environment. A second defective brain wiring 216b causing low self-esteem 214a is the brain wiring causing an individual to find negative aspects in most events. A third defective brain wiring 216c causing low self-esteem 214a is the brain wiring causing an individual fear rejection by other people.

In an embodiment, the information corresponding to the first, second and third defective brain wiring 216a, 216b, 216c causing low self-esteem 214a enables the activity module 200 to select games, activities or actions to overcome low self-esteem.

In an embodiment, displaying the information corresponding to the defective brain wiring (defect) 216a, 216b, 216c causing low self-esteem 214a helps the user in understanding the defects responsible for low self-esteem 214a, thereby motivating the user to follow the instructions provided by the activity module 200.

Information about impact of low self-esteem 216d can include one or more of repeated negative thinking about oneself, tendency to compare oneself with others, tendency to set unrealistic expectations for self, tendency to avoid situations that predict failure, low motivation to fulfill their goals/desires, being defensive when merely being asked for an opinion, idea, or their input on a decision, hyper-vigilance—being constantly anxious and fearful of making a mistake and being overly watchful of the behavior of others, lacking assertiveness, being passive aggressive in behavior, poor communication and social skills, among others.

List of other traits that can be confused with low self-esteem 216e include depression, social anxiety and submissiveness, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome low self-esteem 214a.

With regards to low self-esteem 214a, the brain rewiring attempted to achieve to overcome low self-esteem 214a includes rewiring the defective brain wirings 216a, 216b. 216c such that ability to attribute positive and negative events correctly to either the environment or self is increased, ability to find positive aspects in different life events is increased and ability is increased to separate people who will/have accepted/rejected the person over time, irrespective of specific events.

In an embodiment, the activity module 200 may display the information corresponding to the causes (genetic or environmental) that resulted in the defective brain wirings (defect) 216a, 216b, 216c, which in turn resulted in low self-esteem 214a, thereby enabling the user to relate to the cause, defect and symptom of the defect, which results in an wholesome experience while working to overcome low self-esteem 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204c . . . (may be referred to as game 204 or games 204) may include associated information 218. As an example, a game may be capable of achieving more than one type of brain rewiring. Each game 204 includes data indicating the brain rewiring(s) 219, 225, 231 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria. 100551 in an embodiment, the higher level is unlocked upon repeatedly playing a previous level in the digital game 204 for a predefined number of times or duration of time.

In the example presented in FIG. 2B, Game A 204a is directed at rewiring the brain to increase ability to attribute positive and negative events correctly to either the environment or self 219, Game B 204b is directed at rewiring the brain to increase ability to find positive aspects in different life events 225, and Game C 204c is directed at rewiring the brain to increase ability to separate people who will/have accepted/rejected the person over time, irrespective of specific events 231. The games 204a, 204b, 204c can be used by the activity module 200 to correct the defective brain wirings 216a, 216b, 216c by rewiring the brain. All the games 204 are played/participated in a virtual environment, such as a game in a virtual world.

Game A 204a may be designed to increase the ability to attribute positive and negative events correctly to either the environment or self 219. The instruction 221a may include recommendation to play the game 204a for at least a predefined duration for a predefined number of days. The rules 223a may allow proceeding to a next level in the game 204a once a desired level of performance is achieved.

Game A 204a may present an example of a possible real life situation/event. The user is instructed to attribute events to the environment and to self, based on the facts mentioned.

As an example, the situation could be “you are finding it difficult to get a job”. The facts presented could include companies are downsizing, recession in the market, no work experience and competitors have a qualification from abroad. The game 204a may present a question such as—finding it difficult to get a job, because of you or environment? Further, two choices of answers, such as “environment” and “self” may be presented. The correct answer could be “environment” and the wrong answer could be “self”.

Another example is presented below:

You are finding it difficult to get a job. The activity module 200 may select and display some of the example facts listed below.
Facts about Self:
You have in depth practical knowledge in that field
You have excellent communication skills
Your resume is catchy
You have 2 years of experience in that field
You have done enough research to find a job
   Facts about Environment:
Companies are not paying good salary
There is a recession in the market
There are not enough jobs available in that field
There are too many competitors in the interviews
This is third quarter of the year.
   Question: Finding it difficult to get a job, because of you or environment?

Game B 204b may be designed to increase the ability to find positive aspects in different life events 225. The instruction 221b may include recommendation to play the game 204b for at least a predefined duration for a predefined number of days. The rules 223b may allow proceeding to a next level in the game 204b once a desired level of performance is achieved.

Game B 204b may present an example of a possible real life situation/event (positive, neutral or negative). Multiple aspects of the real life event may be presented, and the user may be instructed to select one or more positive aspects. The game may involve vigorous reasoning about a situation, allowing the user to find out the positives in that situation.

As an example, the situation could be “met with a car accident”. The facts/aspects presented could include had to pay a fine, you got a minor injury, missed an important meeting and all important documents are lost. The game 204b may present a question such as—what is the positive that you can find in this situation? The correct answer could be “you got a minor injury”.

Another example is presented below:

Event: your girl friend/boy friend went to another country for study.
The activity module 200 may select and display some of the example facts listed below.

### Positive Aspects:

You are independent in your life
You have realized the importance of your career in your life
You find more time to reflect on your own thoughts
You spent a lot of time in service
You now find more time for your friends and family

### Negative or Neutral Aspects:

You miss him/her
You were very dependent on him/her
You don't have anybody to share your feelings with
You are unable to talk to him/her on a regular basis
You feel your life is boring without him/her
   Question: What is the positive aspect you find out of this situation?

Game C 204c may be designed to increase the ability to separate people who will accept or reject an individual, or have accepted or rejected the individual over time, irrespective of specific events 231. The instruction 221c may include recommendation to play the game 204c for at least a predefined duration for a predefined number of days. The rules 223c may allow proceeding to a next level in the game 204c once a desired level of performance is achieved.

Game B 204b may present an example of a possible real life situation/event. Multiple facts connected of the may be presented. Further, the user may be presented with a question concerning acceptance or rejection, in response to which the user any provide or select an answer. The game may involve exercising the brain parts that allow the individual to specify rejection to specific people and decrease generalization to all the people around you.

As an example, the situation could be “first day at work”. The facts presented could include you have good past experience, security guard didn't greet well, good introduction given by manager and colleagues speak well to you. The game 204c may present a question such as—would you feel rejected at work? The correct answer could be “no”.

Another example is presented below:

Event: Mark made a presentation today.
The activity module 200 may select and display some of the example facts listed below.

### Positive Facts:

He is a good speaker.
He had prepared well for the presentation.
Most of them clapped at the end of the presentation.
His boss thought his presenting skills are excellent.
He has strong communication skills.

### Negative Facts:

There were other good presenters too.
A few people were distracted.
His presentation lasted long.
A lot of questions were asked.
He was a little late for the presentation.
   Question: Do you think people liked Mark's presentation?
   Answers choices: Yes/No

### Actions Database 206

The actions database 206 includes information corresponding to a plurality of gradual exposure activities or sets of gradual exposure activities. Exposure activities may include activities that are performed in a real world environment, as opposed to the digital games played in the virtual world (ex: games included in the collection of games 204).

Referring to FIG. 2C, each of the exposure activities 220a-220c (may be referred by numeral 220) or sets of exposure activities 220a-220c (may be referred by numeral 220) are used by the activity module 200 based on the brain rewiring, which the exposure activity 220 is capable of achieving.

Each exposure activity 220 may include associated information 222. As an example, an exposure activity may be capable of achieving more than one type of brain rewiring. Each exposure activity 220 includes data indicating the brain rewiring(s) 219, 225, 231 it is capable of achieving, so that the activity module 200 can opt to present a choice of one or more exposure activities 220, which has the capability to achieve the brain rewiring, which the activity module 200 is attempting to achieve.

The associated information 222 may further include instructions 227 to be followed by the user to perform the exposure activity 220 or a set of exposure activities 220. The associated information 222 may additionally include one or more rules 229. Examples of rules include rules to proceed to a higher level, scoring method in each level and time assigned to each level to reach the end of the level, among others.

The exposure activity 220a may be presented to the user after the user has participated in Game A 204a at least to a predefined extent. The exposure activity 220a may be designed to increase the ability to attribute positive and negative events correctly to either the environment or self 219. The instructions/tasks within the exposure activity 220a can include the following:

Think about one positive event that happened during your day;
reflect on whether the event occurred because of you or the environment; and
make an attempt, if needed to collect extra information about the event before coming to a conclusion.
Think about one negative event that happened during your day;
reflect on whether the event occurred because of you or the environment; and
make an attempt, if needed to collect extra information about the event before coming to a conclusion.

The exposure activity 220b may be presented to the user after the user has participated in Game B 204b at least to a predefined extent. The exposure activity 220b may be designed to increase the ability to find positive aspects in different life events 225. The instructions/tasks within the exposure activity 220b can include the following:

### Level 1:

Think about one neutral situation that you encountered during your day; and reflect on any one positive outcome related to that event.

### Level 2:

Think about one negative situation that you encountered during your day; and reflect on any one positive outcome/learning related to that event.

The exposure activity 220c may be presented to the user after the user has participated in Game C 204c at least to a predefined extent. The exposure activity 220c may be designed to increase the ability to separate people who will/have accepted/rejected the person over time, irrespective of specific events 231. The instructions/tasks within the exposure activity 220c can include the following:

### Level 1:

Think about a person who you felt rejected by, today; and
write down one other instance where the same person has accepted you in your past.

### Level 2:

Make a prediction about whether you will be accepted or rejected by someone else, based on the facts that you know. This prediction has to be made about a situation which is about to occur today.

In an embodiment, the action database 220 further includes plurality of physical actions, mind actions and dietary actions, one or more of which may be presented to a user who is trying to overcome low self-esteem 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, exposure activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the exposure activities and determines scores of each level of exposure activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Low Self-Esteem

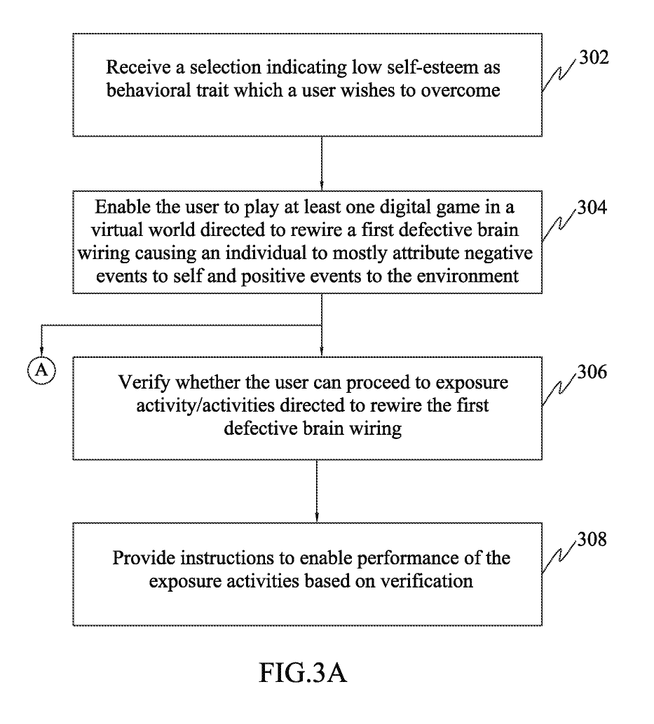

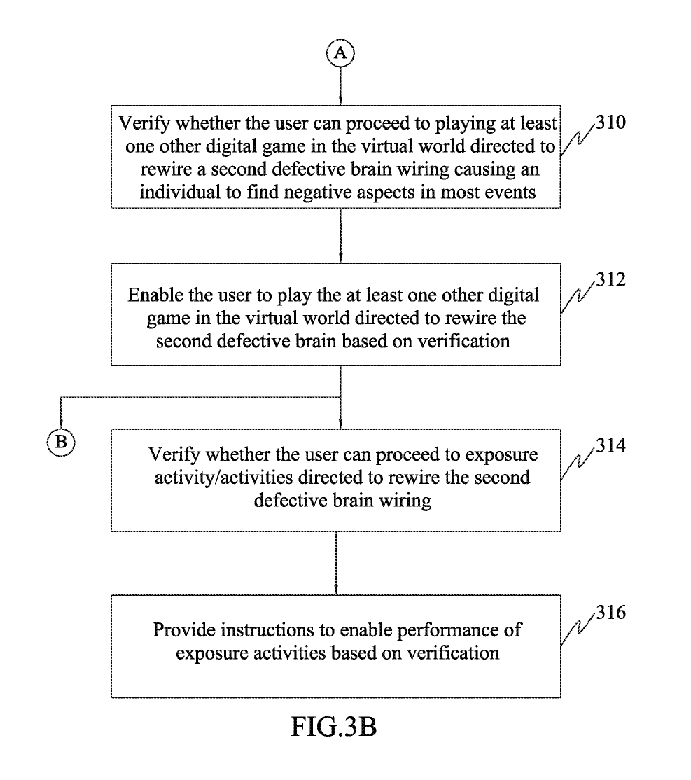

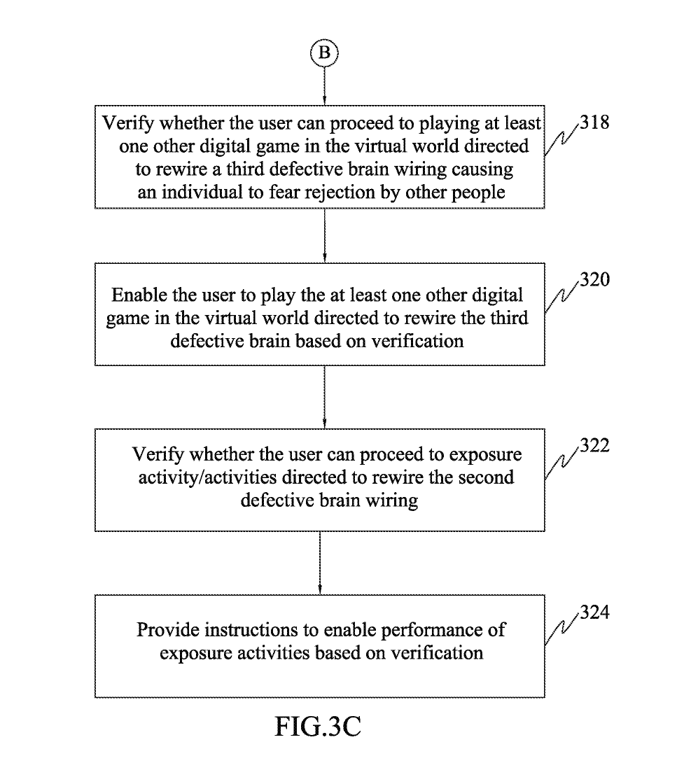

Now referring more particularly to FIGS. 3A-3C, a method is provided for overcoming low self-esteem 214a. A selection indicating low self-esteem 214a as a behavioral trait which a user wishes to overcome is received at step 302. At step 304, a user is enabled to participate/play in at least one digital game 204a, which is played in a virtual world. The digital games 204a is instrumental in rewiring 219 a first defective brain wiring 216a, whose symptom is exhibition of low self-esteem 214a. At step 306, verification is made to determine whether the user can proceed to perform exposure activities 220a. In case it is determined that user can proceed, then at step 308, instructions are provided to the user to enable the user to perform appropriate exposure activity/activities 220a. Preferably, the user is allowed to perform or instructed to begin performing appropriate exposure activities 220a upon participating in the digital game 204a at least to a predefined extent, which is determined based on the desired rewiring. The exposure activity 220a is instrumental in rewiring 219 the first defective brain wiring 216a, whose symptom is exhibition of low self-esteem 214a.

At step 310, verification is made to determine whether the user can proceed to playing at least one other digital game 220b in the virtual world directed to rewire a second defective brain wiring 216b causing an individual to find negative aspects in most events. In case it is determined that user can proceed, then at step 312 the user is enabled to participate/play in at least one digital game 204b, which is played in a virtual world. The digital game 204b is instrumental in rewiring 225 the second defective brain wiring 216b, whose symptom is exhibition of low self-esteem 214a. Preferably, the user is allowed to proceed to playing at least one other digital game 220b upon participating in the game(s) instrumental in rewiring 219 the first defective wiring 216a at least to a predefined extent, which is determined based on the desired rewiring 225.

At step 314, verification is made to determine whether the user can proceed to perform exposure activities 220b. In case it is determined that user can proceed, then at step 316, instructions are provided to the user to enable the user to perform appropriate exposure activity/activities 220b. Preferably, the user is allowed to perform or instructed to begin performing appropriate exposure activities 220b upon participating in the digital games 204b at least to a predefined extent, which is determined based on the desired rewiring 225. The exposure activity 220b is instrumental in rewiring 225 the second defective brain wiring 216b, whose symptom is exhibition of low self-esteem 214a.

At step 318, verification is made to determine whether the user can proceed to playing at least one other digital game 220c in the virtual world directed to rewire a third defective brain wiring 216c causing an individual to fear rejection by other people. In case it is determined that user can proceed, then at step 320 the user is enabled to participate/play in at least one digital game 204c, which is played in a virtual world. The digital game 204c is instrumental in rewiring 231 the third defective brain wiring 216c, whose symptom is exhibition of low self-esteem 214a. Preferably, the user is allowed to proceed to playing at least one other digital game 220c upon participating in the game(s) instrumental in rewiring 219 the second defective wiring 216b at least to a predefined extent, which is determined based on the desired rewiring 225.

At step 322, verification is made to determine whether the user can proceed to perform exposure activities 220c. In case it is determined that user can proceed, then at step 324, instructions are provided to the user to enable the user to perform appropriate exposure activity/activities 220c. Preferably, the user is allowed to perform or instructed to begin performing appropriate exposure activities 220c upon participating in the digital games 204c at least to a predefined extent, which is determined based on the desired rewiring 231. The exposure activity 220c is instrumental in rewiring 231 the third defective brain wiring 216c, whose symptom is exhibition of low self-esteem 214a.

Referring to the step (302) of receiving a selection indicating low self-esteem 214a, the user may be provided an option to select a behavioral trait that he would be like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of low self-esteem 214a, the activity module 200 may display a list 216e of other behavioral traits that can be confused with low self-esteem 214a, so that the user can select a more appropriate behavioral trait 214, which he desires to work on. The activity module 200 may further display the information corresponding to the brain wirings (defect) 216a, 216b, 216c causing the trait behavioral 214. The first defective brain wiring 216a causes an individual to mostly attribute negative events to self and positive events to the environment. The second defective brain wiring 216b causes an individual to find negative aspects in most events. The third defective brain wiring 216c causes an individual to fear rejection by other people.

The activity module 200 may additionally display information about impact 216d of low self-esteem 214a on the user. In addition, the activity module 200 may display information corresponding to the brain rewiring 219, 225, 231 that the activity module 200 is attempting to achieve to overcome low self-esteem 214a. Rewiring 219 of the first defective brain wiring 216a results in increased ability to attribute positive and negative events correctly to either the environment or self. Rewiring 225 of the second defective brain wiring 216b results in increased ability to find positive aspects in different life events. Rewiring 231 of the third defective brain wiring 216c results in increased ability to separate people who will/have accepted/rejected the person over time, irrespective of specific events.

Furthermore, the activity module 200 may display the information corresponding to the causes (genetic or environmental) that resulted in the defective brain wirings (defect) 216a, 216b, 216c.

Referring to the step (304) of enabling the user to play at least one digital game in the virtual world directed to rewire the first defective brain wiring 216a, the activity module 200 may select one or more digital games based on the capability of the digital games (ex: Game A 204a) to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform exposure activities 220. Preferably, the activity module 200 recommends exposure activities 220 after the user has performed to a desired extent in the digital game(s) 204. Desired extent of performance can be, as an example, levels completed, score reached and duration over which the game 204 was played.

In an embodiment, the activity module 200 recommends (step 308) participating in exposure activity 220a after the user has performed to a desired extent in the digital game 204a. Desired extent of performance can be, as an example, levels completed, score reached and duration over which the game 204a was played.

In an embodiment, the activity module 200 recommends participating in a level of exposure activity after the user has performed to a desired extent in a level of the digital game, wherein the level of the digital game prepares the user to participate in the level of the exposure activity.

In an embodiment, the activity module 200 is configured to recommend a plurality of exposure activities or sets of exposure activities 220, wherein the recommendation indicates each of the exposure activities' or sets of exposure activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the exposure activities or sets of exposure activities.

Referring to step 310, the activity module 200 verifies whether the user can proceed to playing at least one other digital game in the virtual world directed to rewire the second defective brain wiring 216b causing an individual to find negative aspects in most events. Rewiring the second defective brain wiring 216b results in increased ability to find positive aspects in different life events 225.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and exposure activity/activities directed to rewire the first defective brain wiring 216a.

The activity module 200, based on the verification, enables the user to play/participate in at least one other digital game 204b in the virtual world directed to rewire the second defective brain wiring.

In an embodiment, the activity module 200 recommends (steps 314, 316) participating in exposure activity 220c after the user has performed to a desired extent in the digital game 204b. Likewise steps 318 to 324 are performed for the third defective wiring 216c, as is done for second defective wiring 216b (steps 310 to 316).

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The exposure, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting low self-esteem, the activity module 200 provides a scale operable by the user to select a position on the scale. The position may be indicative of the user's perception of how low his self-esteem is. Improvement in self-esteem resulting from the rewiring of the brain achieved by the performance of the activities (virtual games or exposure activities) enabled by the activity module 200 is reflected on the scale. Degradation of the improvement in self-esteem resulting from the degradation of the rewiring of the brain due to premature halt in performance of the activities (virtual games or exposure activities) enabled by the activity module 200 is also reflected on the scale.

The games and the exposure activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome low self-esteem, the system comprising an activity module configured to:
enable the user to engage in at least a first activity in a virtual environment, wherein the first activity is directed to rewire a first defective wiring of the brain, wherein the first defective wiring results in an individual mostly attributing negative events to self and positive events to the environment;
enable the user to engage in at least a second activity in the virtual environment, wherein the second activity is directed to rewire a second defective wiring of the brain, wherein the second defective wiring results in an individual finding negative aspects in most events;
enable the user to engage in at least a third activity in the virtual environment, wherein the third activity is directed to rewire a third defective wiring of the brain, wherein the third defective wiring results in an individual fearing rejection by other people, wherein symptom of the first, the second and the third defective wirings is low self-esteem;
provide automated instructions to the user to engage in at least one activity, wherein the one activity is performed in a real world environment, wherein the activity is directed to rewire the first defective wiring of the brain;
provide automated instructions to the user to engage in yet another activity, wherein the yet another activity is performed in the real world environment, wherein the yet another activity is directed to rewire the second defective wiring of the brain; and
provide automated instructions to the user to engage in still another activity, wherein the still another activity is performed in the real world environment, wherein the still another activity is directed to rewire the third defective wiring of the brain.

2. The system of claim 1, wherein the activities in the virtual environment are digital games.

3. The system of claim 1, wherein the activity module is further configured to:
provide the automated instructions to engage in the activity directed to rewire the first defective wiring, to be performed in the real world environment, after the user has at least participated in the first activity:
provide the automated instructions to engage in the activity directed to rewire the second defective wiring, to be performed in the real world environment, after the user has at least participated in the second activity; and
provide the automated instructions to engage in the activity directed to rewire the third defective wiring, to be performed in the real world environment, after the user has at least participated in the third activity.

4. The system of claim 1, wherein the activity module is further configured to enable the user to engage in the second activity, after the user has at least participated in the first activity.

5. The system of claim 1, wherein the activity module is further configured to enable the user to engage in the third activity, after the user has at least participated in the first activity.

6. A method for enabling a user to overcome low self-esteem, the method comprising:
enabling the user to engage in at least a first activity in a virtual environment, wherein the first activity is directed to rewire a first defective wiring of the brain, wherein the first defective wiring results in an individual mostly attributing negative events to self and positive events to the environment;
enabling the user to engage in at least a second activity in the virtual environment, wherein the second activity is directed to rewire a second defective wiring of the brain, wherein the second defective wiring results in an individual finding negative aspects in most events; and
enabling the user to engage in at least a third activity in the virtual environment, wherein the third activity is directed to rewire a third defective wiring of the brain, wherein the third defective wiring results in an individual fearing rejection by other people, wherein symptom of the first, the second and the third defective wirings is low self-esteem.

7. The method of claim 6, further comprising providing automated instructions to the user to engage in at least one activity, wherein the one activity is performed in a real world environment, wherein the activity is directed to rewire the first defective wiring of the brain.

8. The method of claim 7, wherein the automated instructions to engage in the activity directed to rewire the first defective wiring, to be performed in the real world environment, is provided after the user has at least participated in the first activity.

9. The method of claim 6, further comprising providing automated instructions to the user to engage in at least one activity, wherein the one activity is performed in a real world environment, wherein the activity is directed to rewire the second defective wiring of the brain.

10. The method of claim 9, wherein the automated instructions to engage in the activity directed to rewire the second defective wiring, to be performed in the real world environment, is provided after the user has at least participated in the second activity.

11. The method of claim 6, further comprising providing automated instructions to the user to engage in at least one activity, wherein the one activity is performed in a real world environment, wherein the activity is directed to rewire the third defective wiring of the brain.

12. The method of claim 11, wherein the automated instructions to engage in the activity directed to rewire the third defective wiring, to be performed in the real world environment, is provided after the user has at least participated in the third activity.

13. The method of claim 6, wherein the user is enabled to engage in the second activity, after the user has at least participated in the first activity.

14. The method of claim 6, wherein the user is enabled to engage in the third activity, after the user has at least participated in the first activity.

15. The method of claim 6, wherein the user is enabled to engage in the third activity, after the user has at least participated in the second activity.

16. A system for enabling a user to overcome low self-esteem, the system comprising an activity module configured to:
enable the user to engage in at least a first activity in a virtual environment, wherein the first activity is directed to rewire a first defective wiring of the brain, wherein the first defective wiring results in an individual mostly attributing negative events to self and positive events to the environment;
enable the user to engage in at least a second activity in the virtual environment, wherein the second activity is directed to rewire a second defective wiring of the brain, wherein the second defective wiring results in an individual finding negative aspects in most events; and
enable the user to engage in at least a third activity in the virtual environment, wherein the third activity is directed to rewire a third defective wiring of the brain, wherein the third defective wiring results in an individual fearing rejection by other people, wherein symptom of the first, the second and the third defective wirings is low self-esteem.

17. The system of claim 16, wherein,
the first activity is directed to rewire the first defective wiring to increase ability to attribute positive and negative events correctly to either environment or self;
the second activity is directed to rewire the second defective wiring to increase ability to find positive aspects in different life events; and
the third activity is directed to rewire the third defective wiring to increase ability to separate people who will or have, accepted or rejected, the user over time, irrespective of specific event.
